(19) United States
(12) Patent Application Publication
(10) Pub. No.: US 2024/0046603 A1
(43) Pub. Date: Feb. 8, 2024

(54) Optimized Creative and Engine for Generating the Same

(71) Applicant: Kinesso, LLC, New York, NY (US)

(72) Inventor: William Lyman, Nashville, TN (US)

(73) Assignee: Kinesso, LLC, New York, NY (US)

(21) Appl. No.: 18/039,621

(22) PCT Filed: Dec. 1, 2021
(86) PCT No.: PCT/US2021/061371

§ 371 Date: May 31, 2023

Related U.S. Application Data
(60) Provisional application No. 63/120,032, filed on Dec. 1, 2020.

(51) Int. Cl. G06V 10/46; G06V 10/28; G06V 10/82

(52) U.S. Cl. CPC G06V 10/46; G06V 10/28; G06V 10/82

(57) ABSTRACT

A creative is uniquely and optimally customized for every user impression, using the materials and tools available to those wishing to send image- and text-based messages in the market dominated by walled garden platforms, together with a creative e engine process that combines supervised machine learning, relational databases, and generative adversarial networks in a particular configuration that generates the creative. In a first phase, the engine uses machine learning to identify Creative visual features that are associated with high (or low) levels of Performance Metrics when included in Creatives served to Users with a given high-dimensional set of User Attributes. In the second phase, the engine automatically composes Creatives that are composed of visual features that are optimized to create high Performance Metrics when served to Users with a set of attributes that are determined in real time.

### CROSS-REFERENCE TO RELATED APPLICATIONS

This application claims the benefit of U.S. provisional patent application no. 63/120,032, filed on Dec. 1, 2020. Such application is incorporated herein by reference in its entirety.

### BACKGROUND

A programmatic display digital message (an “Impression”) consists of an image (the “Creative”) being served to a digital user (a “User”) in a Web browser or other digital application via the Internet. Before an Impression occurs, a demand-side platform or similar clearing agent (“Platform”) determines which among many possible Creatives will be served to the User. A Platform serves the Creative to the User within 250 milliseconds, and ideally within 5-10 milliseconds. It does so in response to (i) a set of user attributes identified by various parts of the digital programmatic supply chain at the moment immediately preceding the Impression (“User Attributes”), and (ii) a set of pre-existing bid settings submitted to the Platform by the individual participants sending digital messages. These bid settings dictate what each party sending a message is willing to pay for an Impression depending on the User Attributes identified, and the Platform essentially allocates the Impression to the highest bidder. This process constitutes in large part the digital messaging phenomenon called “Targeting,” because it ostensibly allows those sending digital messages to show their Creatives to Users who have some known and desired set of User Attributes.

A parallel function known as dynamic creative optimization (“DCO”) enables limited customization of the Creative that is served in response to the User Attributes. DCO consists primarily of selecting, based on one User Attribute identified in an Impression opportunity, a single Creative from a small set of available Creatives, and of adding or subtracting some small set of text overlays on the Creative.

Both Targeting and DCO are intended to maximize the intended effect of the Impression or Impressions delivered to Users. A given brand may measure the effect of a given Impression or set of Impressions by or one more of a variety of “Performance Metrics.” Different Performance Metrics may measure the cost paid per Impression, the number of Impressions shown to a particular type of User, the number of Impressions that led a User to click on the Impression (each, a “Click”), the cost per Click, the number of Impressions that led to the User making a purchase or other significant commercial action (each, a “Conversion”), the cost per Conversion, the revenue generated by Conversions, the revenue per cost, or various measures of brand awareness usually measured by exogenous User surveys. Most of these Performance Metrics can be deduced from Impression-level log data provided by the Platforms.

Increasingly, Platforms have undergone vertical integration along the audience supply chain, enabling several to create what are known as “walled gardens.” As a result, those sending digital messages are forced to deal with a series of monopolists over individual sections of the digital media landscape. These domain-monopolist Platforms restrict the level of DCO available to those wishing to deliver messages and are not subject to market forces to increase access within the domain they control. This creates a particular challenge for delivering a Creative that is optimized to a given Impression's context.

In addition, different Users respond differently to different types of visual images in Creatives. Those preparing messages in the current environment fail to capitalize on this fact and as a result waste significant amounts of money displaying a given image to all and sundry Users without considering scientifically how the image might be tailored to purpose.

References mentioned in this background section are not admitted to be prior art with respect to the present invention.

### SUMMARY

The present invention is directed to a Creative that is uniquely and optimally customized for every Impression, using the materials and tools available to those wishing to send image- and text-based messages in the market dominated by walled garden platforms, and a creative engine process that combines supervised machine learning, relational databases, and generative adversarial networks in a particular configuration that generates the Creative. An engine to generate the Creative, in certain embodiments, operates in two phases. In the first phase, the engine identifies what Creative visual features are associated with high (or low) levels of Performance Metrics when included in Creatives served to Users with a given high-dimensional set of User Attributes (any such group of Users sharing a relevant such set of User Attributes, an “Audience”). In the second phase, the engine automatically composes Creatives that are composed of visual features that are optimized to create high Performance Metrics when served to a given Audience (each, a “Context-Customized Creative” or “CCC”).

These and other features, objects and advantages of the present invention will become better understood from a consideration of the following detailed description of the preferred embodiments and appended claims in conjunction with the drawings as described following:

### DRAWINGS

FIG. 1 is a flow diagram showing the creation of an Instances Database according to an embodiment of the present invention.

FIG. 2 is a flow diagram showing the creation of the Model according to an embodiment of the present invention.

FIG. 3 is a flow diagram for a generative adversarial network according to an embodiment of the present invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

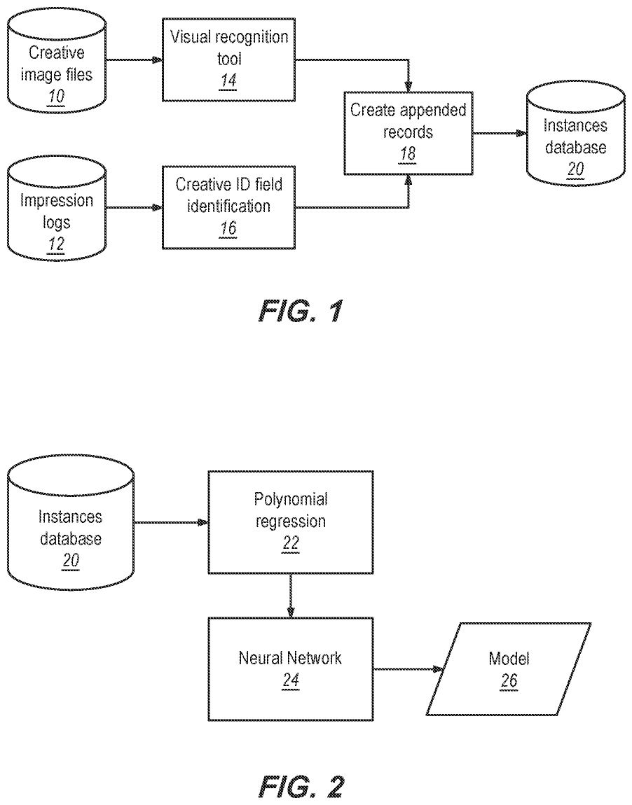

The creative engine according to certain embodiments as described herein operates in two phases. In the first phase, The Creative Engine takes in (i) instances of Creatives—images—that have been delivered in past Impressions, and (ii) Impression-level Platform log data describing the context of each such Impression, including User Attributes and Performance Metrics. Referring now to FIG. 1, these features are drawn from data sources as creative image files 10 and impression logs 12. Impression logs 12 include records that contain both User Attributes as well as corresponding Performance Metrics. A visual recognition tool 14 identifies visual features of each Creative. At the same time, Creative identification (ID) fields are identified in the records from impression logs 12 at Creative ID field identification tool 16. These IDs are used to identify the creative image that was served in each recorded impression event within impression logs 12. The visual features identified in visual recognition tool 14 are then joined via append records tool 18 with the User Attributes and Performance Metrics from each Impression in which such Creative was displayed from Creative ID field identification tool 16. This creates a relational database 20 that, for each historical Impression, associates User Attributes, visual features and Performance Metrics (the “Instances Database” or just “Database”20). The Instances Database 20 contains instances associating User Attributes, visual features, and performance indicators. The Database is stored in a remote-accessible virtual object storage system.

Referring now to FIG. 2, a series of machine learning techniques is used to identify and/or synthesize key significant features from Instances Database 20 and produce a model 26 of the relationship between these and performance when controlling for particular sets of User Attributes (the “Model”). The fundamental technique is one of supervised learning, which takes the form of a polynomial regression 22 where the feature variables are various visual features as well as User Attributes of the desired Audience, and the objective variable is a chosen Performance Metric. A neural network algorithm 24 then takes in the outputs of the regression algorithm to identify salient features and synthesize salient hyperfeatures, as well as parse the semantic rules that govern the composition of visual features in the Creatives in question. Semantic rules describe ways in which individual visual features interact, such as “if there is one human inside an automobile and the image is displayed in North America, the human appears on the viewer's right side of the automobile.” These semantic rules impose a logical order on visual compositions so that the neural network can approach the composition problem hierarchically, much as human beings process the visual world: treat individual visual features as discrete and finite objects on one level and then arrange these objects into coherent compositions using semantic rules on a second level. As a result, the CCC will be optimized on both levels of human perception and therefore be more effective.

For completeness in understanding the eventually-resulting CCC, we describe the model 26 as follows. Model 26 expresses the expected performance of an Impression as a function of (1) User Attributes and (2) visual features. Model 26 takes the form of an equation of the form:

p=f(U,V) Eq. 1

### Where:

p is a value of the Performance Metric in question.
U is a vector of User Attribute values (u₁, u₂, . . . , uₘ) that describe the user being served the Impression. A given uᵢ can represent the geographic location of the user being served the Impression, the type of device on which the user is being served the Impression, etc.
V is a vector of visual feature values (v₁, v₂, . . . , vₙ) that describe the image served in the Impression. A given v₁ can represent the average color of an image, the level of complexity of an image, the presence or absence of a human in an image, the distribution of colors in an image, etc. The visual features vector V will be exceedingly long and will have to incorporate semantic rules as described above.
f is a function that captures the interactions among the components of V when U is held constant at a particular chosen value describing an Audience of Users of interest, in determining P. The machine learning algorithms described above generate a value for f based on the training instances of Creatives and Platform log events that constitute the training data. It is this function that constitutes the f Model.

Model 26 just described can serve as a stand-alone tool that outputs insights on high- and low-performing visual features for given Audiences, and it may also feed essentially these same insights into the second phase of the creative engine as described following. As a stand-alone tool, insights from Model 26 can be used in the composition of Creatives by traditional human professional visual artists, as well as in the selection of Creatives by professionals tasked with targeting particular Audiences.

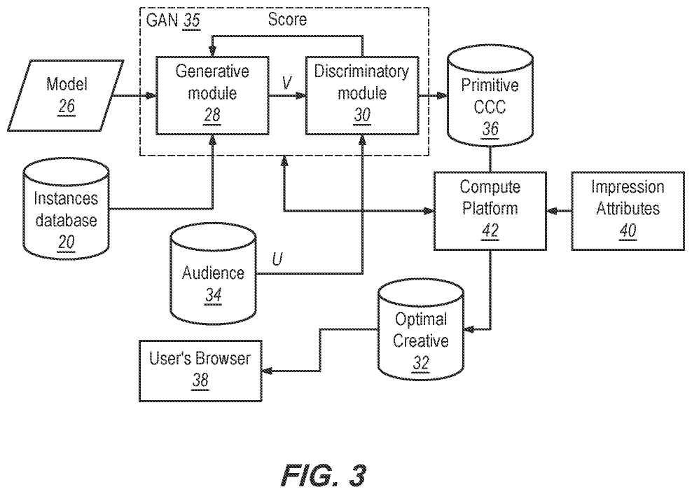

Incorporating the Model as a component of the Creative Engine, a generative adversarial network (“GAN”) 35 uses the Model as its training data set in phase two, as illustrated in FIG. 3. The GAN 35 according to an embodiment of the present invention is a type of artificial intelligence algorithm that consists of two modules: the first generative and the second discriminatory. The generative module 28 generates examples of Creatives, varying the values of salient visual features and hyperfeatures and trying to both follow the semantic rules understood in the Model and to maximize the Performance Metrics predicted by the Model 26. The discriminatory module 30 then scores the output of the generative module 28 on how closely it approaches those two goals.

The above-described process then iterates, meaning that the first guesses of generative module 28 are highly random, but that it tries again after the discriminatory module 30 scores it. The generative module 28 thus learns from each score attributed by the discriminatory module 30 until it reaches some desired level of closeness to the desired object. Because each iteration is a mix of random guesses and adjustments learned from the scoring of discriminatory module 30, each instance of the output object (here, each optimal Creative 32 composed by the creative engine of the embodiment) is still a unique object.

The GAN 35 works with Equation 1 above from the first phase as embodied in model 26. The GAN 35 starts its work only after an Audience 34 has been determined, meaning that the User Attribute values in the vector U are fixed either to deterministic values or stochastic sets of values with known probabilities of occurring. The GAN's function, then, is to select values of the visual features vector V that maximize the expected performance level p when combined with the fixed values of the User Attribute vector U, and to do so with the semantic rules determined by the Model 26.

Following the iterative process described above, the generative module 28 first outputs a random set of values of V, which set of values, in combination with the U values fixed by the Audience 34 in question creates a value for p. The discriminatory module then scores this output on its adherence to the semantic rules as well as the value of p it creates. The generative module then tries again, and the process is iterated until the generative module has output a vector V that the discriminatory module scores as both (i) fitting sufficiently within the semantic rules so that the image it composes actually looks like the thing intended (a person, etc.), and (ii) the value of p it creates per Eq. 1 is optimal.

The above-described process then iterates, meaning that the first guesses of generative module 28 are highly random, but that it tries again after the discriminatory module 30 scores it. The generative module 28 thus learns from each score attributed by the discriminatory module 30 until it reaches some desired level of closeness to the desired object. Because each iteration is a mix of random guesses and adjustments learned from the scoring of discriminatory module 30, each instance of the output object (here, each optimal Creative 32 composed by the Creative Engine) is still a unique object.

In asynchronous time, the GAN 35 produces an initial set of primitive CCCs for expected high-frequency User Attribute profiles, running on an elastic virtual computing platform, reading the Database 20 and the Model 26 from the remote object storage location. These primitive CCCs can be either a finite set of complete CCCs, or partially composed creatives, with foundational variables optimized for Users with expected high-frequency subsets of User Attributes (in order to avoid processing these variables in real time at the moment of the Impression). In either case, CCCs 36 are stored in a second, high-speed object storage location.

In real time at the moment of the Impression, a set of Impression User Attributes arrive at a second elastic virtual computing platform 42. In a first embodiment, platform 42 identifies a pre-computed primitive CCC 36 from the set of primitive CCCs that most closely matches the Impression User Attributes 40, whereby primitive CCC 36 is deemed the optimal Creative 32 and returned to the User's Browser 38. In a second embodiment, platform 42 identifies the primitive CCC from primitive CCCs 36 most closely matching the Impression User Attributes 40. Platform 42 runs the GAN 35 to bring the selected primitive CCC 36 into optimal alignment by using the incremental difference between the Impression User Attributes 40 and the closest U values within GAN 35 fixed by the Audience 34 to incrementally adjust the visual features and hyperfeatures, producing a final CCC or optimal Creative 32. The virtual computing platform then delivers the final CCC to the User's Browser 38. As will be understood from the foregoing, the Context-Customized Creative is therefore a unique visual Creative that appears in the real-time moment of a digital media Impression that is optimized to maximize performance for the User and context in place at the time.

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and displays as illustrated in the figures and described herein represent example implementations. The order of any method may be changed, and various elements may be added, modified, or omitted.

A computing system or computing device as described herein may implement a hardware portion of a cloud computing system or non-cloud computing system, as forming parts of the various implementations of the present invention. The computer system may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the computer system may implement one or more nodes of a control plane or control system, and persistent storage may include the SSDs attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system's memory capabilities may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system (not shown), which may be any of various operating systems, such as UNIX, LINUX, Solaris™, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment, grid computing environment, or other system involving multiple computer systems. Multiple input/output devices may be present in communication with the computer system or may be distributed on various nodes of a distributed system that includes the computer system. The user interfaces described herein may be visible to a user using various types of display screens, which may include CRT displays, LCD displays, LED displays, and other display technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel SANs, or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A method for automatically generating an optimally customized creative, the method comprising the steps of:
at a generative adversarial network, applying a plurality of instance records as a training data set to a supervised machine learning model, wherein each of the plurality of instance records comprises a creative identification field, at least one user attribute, at least one visual feature, and at least one performance metric;
at a generative module within a generative adversarial network, generating a plurality of example creatives;
at the generative module, varying the values of salient visual features within the plurality of example creatives to synthesize hyperfeatures within the plurality of example creatives;
parsing a set of semantic rules that govern composition of the visual features in the creative image files;
from the synthesized hyperfeatures and parsed set of semantic rules, generating at the generative module a prediction for the optimally customized creative;
at a discriminatory module within the generative adversarial network, scoring the prediction from the generative module and provide a resulting score back to the generative module;
iteratively repeating the steps of generating the prediction at the generative module and scoring the prediction at the discriminatory module until the optimally customized creative is produced.

2. The method for automatically generating an optimally customized creative of claim 1, wherein the step of generating a plurality of example creatives comprises the step of generating a set of primitive context-customized creatives and storing the set of primitive context-customized creatives in a primitive context-customized creatives database.

3. The method for automatically generating an optimally customized creative of claim 1, further comprising the step of delivering the optimally customized creative across a network to a user's browser.

4. The method for automatically generating an optimally customized creative of claim 3, further comprising the step of receiving a request to serve an impression prior to producing the optimally customized creative for delivery across the network to the user's browser.

5. The method for automatically generating an optimally customized creative of claim 4, wherein the delivery of the optimally customized creative across the network to the user's browser occurs within 250 milliseconds from receiving the request to serve an impression.

6. The method for automatically generating an optimally customized creative of claim 1, wherein the supervised machine learning model is a polynomial regression model wherein a set of feature variables are the user attributes and the visual features and an objective variable is at least one of the chosen performance metrics.

7. The method for automatically generating an optimally customized creative of claim 1, further comprising the step of providing a desired audience from an audience database to the supervised machine learning model and applying the polynomial regression model to the desired audience.

8. The method for automatically generating an optimally customized creative of claim 6, further comprising the step of receiving an output from the polynomial regression model at a neural network and synthesizing the salient hyperfeatures in the neural network.

9. The method for automatically generating an optimally customized creative of claim 1, further comprising the steps of:
using a visual identification tool, identifying visual features in a plurality of creative image files from a creative image files database;
using an impression logs database that comprises a plurality of impression logs records each comprising a user attribute and at least one performance metric corresponding to the user attribute, identifying a set of user attributes corresponding to performance indicators;
for each identified visual feature, returning a creative identification field from the plurality of impression logs records, wherein each creative identification field is drawn from one of the impression logs records that contains a corresponding user attribute;
using the creative identification field, building the plurality of instances records, wherein each instance record comprises a creative identification field, a corresponding user attribute, a corresponding visual feature, and at least one corresponding performance metric;
storing the plurality of instances records in an instances database.

10. An engine for automatically creating an optimally customized creative, comprising:
an instances database comprising a plurality of instance records;
a generative adversarial network in communication with the instances database and configured to apply the plurality of instance records as a training data set to a supervised machine learning model, wherein each of the plurality of instance records comprises a creative identification field, at least one user attribute, at least one visual feature, and at least one performance metric;
wherein the generative adversarial network comprises a generative module configured to generate a plurality of example creatives, vary the values of salient visual features within the plurality of example creatives to synthesize hyperfeatures within the plurality of example creatives, parse a set of semantic rules that govern composition of the visual features in the creative image files, and, from the synthesized hyperfeatures and parsed set of semantic rules, generate a prediction for the optimally customized creative; and
wherein the generative adversarial network further comprises a discriminatory module configured to iteratively score the prediction from the generative module and provide a resulting score back to the generative module until a sufficiently high score is provided to indicate that the prediction is the optimally customized creative.

11. The engine for automatically creating an optimally customized creative of claim 10, further comprising a primitive context-customized creatives database, wherein the generative module is further configured to generate a set of primitive context-customized creatives and store the set of primitive context-customized creatives in the primitive context-customized creatives database.

12. The engine for automatically creating an optimally customized creative of claim 10, further comprising a compute platform configured to deliver the optimally customized creative across a network to a user's browser.

13. The engine for automatically creating an optimally customized creative of claim 12, wherein the compute platform is configured to receive a request to serve an impression prior to the generative adversarial network producing the optimally customized creative.

14. The engine for automatically creating an optimally customized creative of claim 13, wherein the compute platform is configured to deliver the optimally customized creative across the network to the user's browser within 250 milliseconds from the compute platform receiving the request to serve an impression.

15. The engine for automatically creating an optimally customized creative of claim 10, wherein the supervised machine learning model is a polynomial regression model wherein a set of feature variables are the user attributes and the visual features and an objective variable is at least one of the chosen performance metrics.

16. The engine for automatically creating an optimally customized creative of claim 10, further comprising an audience database, and wherein the generative adversarial network is further configured to provide a desired audience from an audience database to the supervised machine learning model and applying the polynomial regression model to the desired audience.

17. The engine for automatically creating an optimally customized creative of claim 15, further comprising a neural network configured to receive an output from the polynomial regression model and synthesizing the salient hyperfeatures in the neural network.

18. The engine for automatically creating an optimally customized creative of claim 10, further comprising:
a creative image files database comprising a plurality of creative image files;
a visual identification tool in communication with the creative image files database and configured to identify visual features in the plurality of creative image files;
an impression logs database comprising a plurality of impression logs records, each impression log record comprising a user attribute and at least one performance metric corresponding to the user attribute;
a creative ID field identification module in communication with the impression logs database and configured to, for each identified visual feature, return a creative identification field from the plurality of impression logs records, wherein each creative identification field is drawn from one of the impression logs records that contains a corresponding user attribute;
a create appended records module configured to use the creative identification field to build the plurality of instances records, wherein each instance record comprises a creative identification field, a corresponding user attribute, a corresponding visual feature, and at least one corresponding performance metric; and
store the plurality of instances records in an instances database.
